(19) United States
(12) Patent Application Publication
(10) Pub. No.: US 2023/0065152 A1
(43) Pub. Date: Mar. 2, 2023

(54) IMAGING LENS

(71) Applicant: Rays Optics Inc., Hsinchu County (TW)

(72) Inventor: Ching-Lung Lai, Hsinchu County (TW)

(73) Assignee: Rays Optics Inc., Hsinchu County (TW)

(21) Appl. No.: 17/881,624

(22) Filed: Aug. 5, 2022

(30) Foreign Application Priority Data
Aug. 25, 2021 (TW) 110131444

(51) Int. Cl. G02B 9/04; G02B 13/18

(52) U.S. Cl. CPC G02B 9/04; G02B 13/18

(57) ABSTRACT

An imaging lens including a first lens group and a second lens group. Each of the first lens group and the second lens group includes three lenses with refractive power. The first lens group includes two aspheric lenses and a glass lens, and an outermost lens surface of the first lens group facing an object side is a spherical surface. The second lens group includes an aspheric lens and a glass lens, and the second lens group includes a cemented surface. An aperture stop of the imaging lens is disposed between the first lens group and the second lens group.

### CROSS REFERENCE TO RELATED APPLICATION

This application claims the priority benefit of Taiwanese application serial no. 110131444, filed on Aug. 25, 2021. The entirety of the above-mentioned patent application is hereby incorporated by reference herein and made a part of this specification.

### BACKGROUND

### Technical Field

The disclosure relates to an optical lens, and in particular to an imaging lens.

### Description of Related Art

In recent years, electronic products with camera function can be used in various fields, such as security surveillance, in-car camera system, action camera. In these situations, optical imaging lenses with wide viewing angles, miniaturization, and high image quality are required.

However, the traditional wide-angle lens is not easy to reduce the lens volume due to the limitation of lens shape and lens material, and is also difficult to have both the image quality under wide viewing angle and the image quality under large aperture.

### SUMMARY

The disclosure provides an imaging lens capable of meeting the needs of wide viewing angle, high image quality, and miniaturization.

An imaging lens according to embodiments of the disclosure includes a first lens group and a second lens group. The first lens group and the second lens group respectively include three lenses with refractive power. The lenses of the first lens group include two aspheric lenses and a glass lens, and an outermost lens surface of the first lens group facing an object side is a spherical surface. The lenses of the second lens group include an aspheric lens and a glass lens, and the second lens group includes a cemented surface. An aperture stop of the imaging lens is disposed between the first lens group and the second lens group. The imaging lens meets the following conditions: 0.15 <EFL/LT<0.25 and 0.5<D1/LT<1.5. EFL is an effective focal length of the imaging lens. LT is a distance on an optical axis between outermost two lens surfaces of the first lens group and the second lens group. D1 is a diameter of an outermost surface of an outermost lens of the first lens group facing the object side.

An imaging lens according to the embodiments of the disclosure includes a first lens, a second lens, a third lens, a fourth lens, a fifth lens, and a sixth lens arranged in order from an object side to an image side of the imaging lens, and an aperture stop disposed between the third lens and the fourth lens. The first lens is a glass lens, and at least one of the fourth lens, the fifth lens, and the sixth lens is a glass lens. The second lens from the image side in the imaging lens is a negative lens. The third lens from the image side is a positive lens. An interval between the second lens from the image side and the third lens from the image side is less than 0.3 mm. At the same time, the imaging lens meets the following conditions: 0.5 <D1/LT<1.5. LT is a distance on an optical axis between outermost two lens surfaces of the imaging lens. D1 is a diameter of an outermost surface of the first lens.

Based on the above, the imaging lens according to the embodiments of the disclosure is capable of providing good image quality under wide viewing angle and large aperture conditions by meeting the above-mentioned element characteristics and configuration conditions, and may also take into account the need for miniaturization.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of an imaging lens according to a first embodiment of the disclosure.

FIGS. 2A to FIGS. 2D are diagrams illustrating aberrations of the imaging lens according to the first embodiment.

FIG. 3 is a schematic diagram of an imaging lens according to a second embodiment of the disclosure.

FIGS. 4A to FIGS. 4D are diagrams illustrating aberrations of the imaging lens according to the second embodiment.

FIG. 5 is a schematic diagram of an imaging lens of according to a third embodiment of the disclosure.

FIGS. 6A to FIGS. 6D are diagrams illustrating aberrations of the imaging lens according to the third embodiment.

FIG. 7 is a schematic diagram of an imaging lens of according to a fourth embodiment of the disclosure.

FIGS. 8A to FIGS. 8D are diagrams illustrating aberrations of the imaging lens according to the fourth embodiment.

### DESCRIPTION OF THE EMBODIMENTS

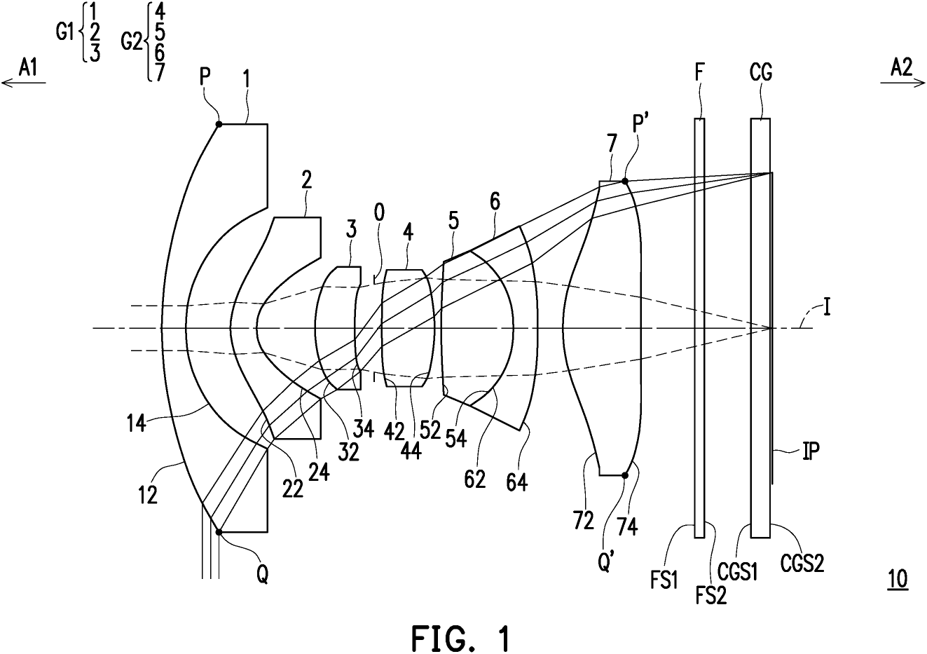

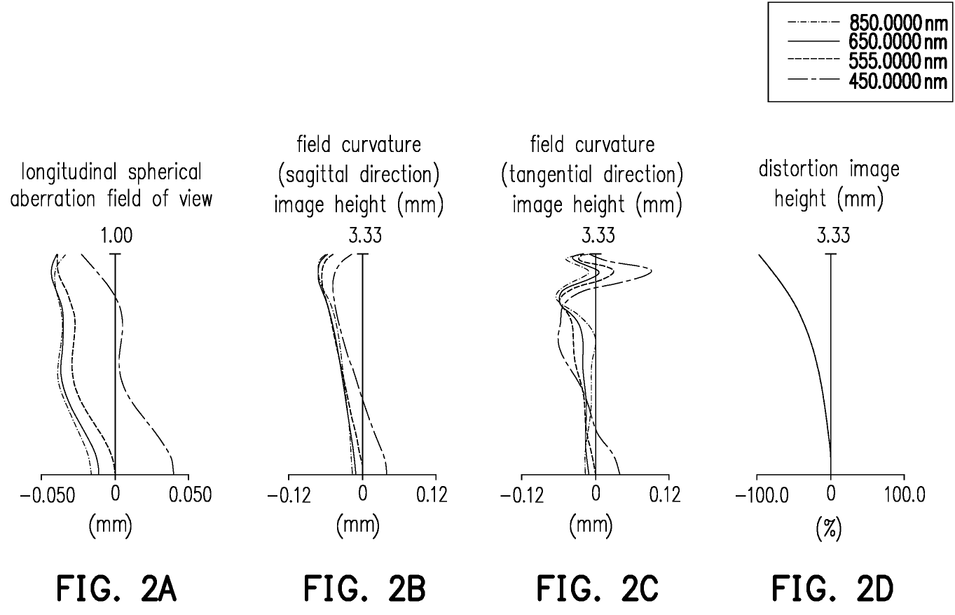

FIG. 1 is a schematic diagram of an imaging lens according to a first embodiment of the disclosure. FIGS. 2A to FIGS. 2D are diagrams illustrating aberrations of the imaging lens according to the first embodiment. Referring FIG. 1 first, an imaging lens 10 includes a first lens 1, a second lens 2, a third lens 3, a fourth lens 4, a fifth lens 5, a sixth lens 6, a seventh lens 7, a filter F, and a plate CG arranged in order from an object side A1 to an image side A2 of the imaging lens 10, and an aperture stop 0 disposed between the third lens 3 and the fourth lens 4. The aperture stop 0 is, for example, a light-shielding element such as an aperture. In some embodiments, the aperture stop 0 may also not be a separate optical element, but an inner diameter of a lens barrel as the aperture stop 0. Light emitted from an object to be photographed may enter the imaging lens 10, sequentially pass through the first lens 1, the second lens 2, the third lens 3, the aperture stop 0, the fourth lens 4, the fifth lens 5, the sixth lens 6, and the seventh lens. 7, the Filter F, and the plate CG, and form an image on an image plane IP. The object side A1 is toward a side of the object to be photographed, and the image side A2 is toward a side of the image plane IP.

In this embodiment, each of the first lens 1, the second lens 2, the third lens 3, the fourth lens 4, the fifth lens 5, the sixth lens 6, the seventh lens 7, the filter F, and the plate CG of the imaging lens 10 has an object side surface 12, 22, 32, 42, 52, 62, 72, FS1, and CGS1 facing the object side A1 through which imaging light passes, and an image side surface 14, 24, 34, 44, 54, 64, 74, FS2, and CGS2 facing the image side A2 through which the imaging light passes.

In detail, the first lens 1 is a glass lens and a spherical lens. The first lens 1 has negative refractive power and is a convex-concave lens. The object side surface 12 of the first lens 1 is a convex surface, and the image side surface 14 is a concave surface. The object side surface 12 and the image side surface 14 of the first lens 1 are spherical surfaces, but the disclosure is not limited thereto.

The second lens 2 is a plastic lens and an aspheric lens. The second lens 2 has negative refractive power. The object side surface 22 and the image side surface 24 of the second lens 2 are aspheric surfaces, but the disclosure is not limited thereto.

The third lens 3 is a plastic lens and an aspheric lens. The third lens 3 has positive refractive power. The object side surface 32 and the image side surface 34 of the third lens 3 are aspheric surfaces, but the disclosure is not limited thereto.

The fourth lens 4 is a glass lens and an aspheric lens. The fourth lens 4 has positive refractive power. The object side surface 42 and the image side surface 44 of the fourth lens 4 are aspheric surfaces, but the disclosure is not limited thereto. In this embodiment, the fourth lens 4 is a glass molded lens, but the disclosure is not limited thereto.

The fifth lens 5 is a plastic lens and an aspheric lens. The fifth lens 5 has positive refractive power. The object side surface 52 and the image side surface 54 of the fifth lens 5 are aspheric surfaces, but the disclosure is not limited thereto.

The sixth lens 6 is a plastic lens and an aspheric lens. The sixth lens 6 has negative refractive power. The object side surface 62 and the image side surface 64 of the sixth lens 6 are aspheric surfaces, but the disclosure is not limited thereto.

The fifth lens 5 and the sixth lens 6 are joined on the image side surface 54 of the fifth lens and the object side surface 62 of the sixth lens 6 to form a cemented lens. In this embodiment, a cemented surface of the fifth lens 5 and the sixth lens 6 is an aspheric surface, and the fifth lens 5 and the sixth lens 6 form a plastic cemented lens.

The seventh lens 7 is a plastic lens and an aspheric lens. The seventh lens 7 has positive refractive power. The object side surface 72 and the image side surface 74 of the seventh lens 7 are aspheric surfaces, but the disclosure is not limited thereto.

The filter F is disposed between the seventh lens 7 and the image plane IP, the filter F may allow light of an appropriate wavelength (e.g. infrared or visible light) to pass and block light of other wavelengths, but the disclosure is not limited thereto.

The flat CG may be any suitable plate made of light-transmitting material. The flat CG may adjust a length of an imaging device and also provide protection.

In this embodiment, a number of lenses with refractive power in the imaging lens 10 is substantially seven. An effective focal length (EFL) of the imaging lens 10 according to the first embodiment of the disclosure is 1.94 millimeter (mm). An effective focal length (EFL2) of a second lens group G2 is 3.19 millimeter (mm). An f⁻number (F#) is 2. A field of view (FOV) is 178 degrees. A total system length (TTL) is 13 mm, and a maximum image height is 3.3173 mm. The total system length is a distance on an optical axis I from the object side surface 12 of the first lens 1 to the image plane IP of the imaging lens 10.

Other details of optical data of the imaging lens 10 according to the first embodiment are shown in Table 1 below. “Interval/Thickness” column lists a distance between the surfaces. The distance indicates a thickness of each lens or optical element on the optical axis I, or a distance between the surfaces of each lens or plate and a next optical element on the optical axis I. For example, in row “12”, “Interval/Thickness” indicates a thickness of the first lens 1 on the optical axis I, while in row “14”, “Interval/Thickness” indicates a thickness between the first lens 1 and the second lens 2, and so on. In “Type” column, the lens surface is marked as “aspheric” surface or “spherical” surface. In addition, in “Remarks” column, in addition to the corresponding optical element or lens surface, the lens material and other characteristics are also marked.

Table 1

first embodiment

| Surface No. | Radius of curvature (mm) | Interval/ Thickness (mm) | Refractive index | Abbe number | Type | Remark |
|---|---|---|---|---|---|---|
| 12 | 8.47 | 0.500 | 1.75 | 52 | spherical surface | first lens 1 (glass) |
| 14 | 2.76 | 0.964 | | | spherical surface | |
| 22 | 1.58 | 0.550 | 1.54 | 56 | aspheric surface | second lens 2 (plastic) |
| 24 | 0.81 | 1.243 | | | aspheric surface | |
| 32 | 3.00 | 0.843 | 1.66 | 20 | aspheric surface | third lens 3 (plastic) |
| 34 | 8.22 | 0.422 | | | aspheric surface | |
| | Infinity | 0.167 | | | | aperture stop 0 |
| 42 | 55.03 | 1.116 | 1.50 | 81 | aspheric surface | fourth lens 4 (glass) |
| 44 | -3.30 | 0.145 | | | aspheric surface | |
| 52 | 12.12 | 1.527 | 1.54 | 56 | aspheric surface | object side surface of fifth lens 5 (plastic) |
| 54 | -1.77 | 0.008 | 1.50 | 56 | aspheric surface | image side surface of fifth lens 5 (plastic) / cement |
| 62 | -1.77 | 0.515 | 1.66 | 20 | aspheric surface | sixth lens 6 (plastic) |
| 64 | -15.95 | 0.540 | | | aspheric surface | |
| 72 | 2.65 | 1.660 | 1.54 | 56 | aspheric surface | seventh lens 7 (plastic) |
| 74 | -35.98 | 1.145 | | | aspheric surface | |
| FS1 | Infinity | 0.210 | 1.52 | 64 | | filter F |
| FS2 | Infinity | 1.000 | | | | |
| CGS1 | Infinity | 0.400 | 1.52 | 64 | | plate CG |
| CGS2 | Infinity | 0.045 | | | | |
| IP | Infinity | 0 | | | | image plane IP |

In this embodiment, the object side surface 22 of the second lens 2, the object side surface 32 of the third lens 3, the object side surface 42 of the fourth lens 4, the object side surface 52 of the fifth lens 5, the object side surface 62 of the sixth lens 6, the object side surface 72 of the seventh lens 7, the image side surface 24 of the second lens 2, the image side surface 34 of the third lens 3, the image side surface 44 of the fourth lens 4, the image side surface 54 of the fifth lens 5, the image side surface 64 of the sixth lens 6, and the image side surface of the seventh lens 7 are aspheric surfaces, and these aspheric surfaces are defined according to the following equation:

$$\text{Z} \left(\text{Y}\right) = \frac{{Y}^{2}}{R} / \left(1 + \sqrt{1 - \left(1 + K\right) \frac{{Y}^{2}}{{R}^{2}}}\right) + {\sum }_{i = 1}^{n} {\text{a}}_{2 i} \times {Y}^{2 i}$$

Therein:
R: a radius of curvature of the lens surface near the optical axis I;
Y: a vertical distance from a point on an aspheric curve to the optical axis I;
Z: a depth of the aspheric surface (a perpendicular distance between the point on the aspheric surface that is spaced from the optical axis I by the distance Y and a tangent plane tangent to a vertex of the aspheric surface on the optical axis I);
K: conic constant;
a₂i: a 2i^{th} aspheric coefficient.

The conic constant of each aspheric surface in equation (1) and each aspheric coefficient according to this embodiment are shown in Table 2. Column no. 22 in Table 2 indicates a conic constant and aspheric coefficients of the object side surface 22 of the second lens 2, and so on for other columns. In each embodiment of the disclosure, a 2^{th} aspheric coefficient (a2) of each aspheric surface in equation (1) is 0.

Table 2

| | conic constant | 4^{th} aspheric coefficient | 6^{th} aspheric coefficient | 8^{th} aspheric coefficient | 10^{th} aspheric coefficient | 12^{th} aspheric coefficient | 14^{th} aspheric coefficient | 16^{th} aspheric coefficient |
|---|---|---|---|---|---|---|---|---|
| 22 | -2.07 | -4.92E-03 | -7.26E-03 | 3.69E-03 | -1.14E-03 | 2.14E-04 | -2.13E-05 | 8.54E-07 |
| 24 | -0.93 | -3.38E-02 | -2.44E-03 | -2.68E-03 | 1.53E-02 | -1.23E-02 | 3.95E-03 | -4.84E-04 |
| 32 | 2.78 | 1.86E-02 | 8.52E-03 | 4.60E-03 | -5.40E-03 | 3.26E-03 | -7.04E-04 | 0.00E+00 |
| 34 | 40.06 | 4.53E-02 | 3.67E-02 | -2.85E-02 | 3.54E-02 | -8.24E-03 | 0.00E+00 | 0.00E+00 |
| 42 | 0.00 | 3.32E-02 | 2.46E-03 | 1.56E-03 | -1.72E-03 | 0.00E+00 | 0.00E+00 | 0.00E+00 |
| 44 | -7.13 | -1.27E-02 | -9.74E-03 | -2.31E-04 | 2.87E-03 | -1.47E-03 | -4.47E-04 | 2.69E-04 |
| 52 | -13.34 | 1.08E-02 | -1.37E-02 | 1.62E-03 | 4.60E-03 | -4.56E-03 | 1.77E-03 | -2.98E-04 |
| 54 | -1.03 | 6.29E-02 | -1.72E-01 | 2.16E-0 1 | -1.51E-01 | 5.90E-02 | -1.29E-02 | 1.23E-03 |
| 62 | -1.03 | 6.29E-02 | -1.72E-01 | 2.16E-0 1 | -1.51E-01 | 5.90E-02 | -1.29E-02 | 1.23E-03 |
| 64 | 45.76 | -1.84E-02 | -1.61E-03 | 7.43E-03 | -4.15E-03 | 1.08E-03 | -1.40E-04 | 7.31E-06 |
| 72 | -5.50 | 3.24E-03 | -2.65E-03 | 1.02E-03 | -2.54E-04 | 3.31E-05 | -2.06E-06 | 4.75E-08 |
| 74 | -0.01 | 1.26E-02 | -4.70E-03 | 1.01E-03 | -1.72E-04 | 1.70E-05 | -7.66E-07 | 1.01E-08 |

According to the above, the imaging lens 10 according to this embodiment meets the following conditions: the first lens 1 is a glass lens, and at least one of the fourth lens 4, the fifth lens 5, and the sixth lens 6 is a glass lens; in this embodiment, the fourth lens 4 is a glass lens; the fifth lens 5 and the sixth lens 6 are plastic lenses, but in other embodiments, the fifth lens 5 and the sixth lens 6 may also be glass lenses. In the imaging lens 10, the second lens from the image side A2 (the sixth lens 6) is a negative lens, the third lens from the image side A2 (the fifth lens 5) is a positive lens, and an interval between the second lens from the image side A2 and the third lens from the image side A2 is less than 0.3 mm. The fourth lens 4 is a glass molded lens and is an aspheric lens. In addition, in the imaging lens 10, a distance between a concave surface and a convex surface closest to each other (the image side surface 54 of the fifth lens 5 and the object side surface 62 of the sixth lens 6) is less than 0.3 mm. Furthermore, the imaging lens 10 includes at least five aspheric lenses. In detail, the second lens 2, the third lens 3, the fourth lens 4, the fifth lens 5, the sixth lens 6, and the seventh lens 7 are aspheric lenses. A full field of view of the imaging lens 10 falls within a range of 170 degrees to 190 degrees.

The imaging lens 10 according to this embodiment may have the following features. The first lens 1 is a glass lens, and therefore has higher hardness and improved abrasion resistance. In addition, light transmittance of the imaging lens 10 according to this embodiment may also be improved to enhance imaging quality. At least one of the fourth lens 4, the fifth lens 5, and the sixth lens 6 is a glass lens. Due to thermal expansion coefficient property of the glass lens, the fourth lens 4 may compensate for thermal drift by using a glass lens to ensure the imaging quality of the imaging lens 10 according to this embodiment. The use of plastic lenses for the fifth lens 5 and the sixth lens 6 may reduce the production cost of the imaging lens 10 of this embodiment, of which the same material is preferred for the fifth lens 5 and the sixth lens 6. In the imaging lens 10, the second lens from the image side A2 is a negative lens, and the third lens from the image side A2 is a positive lens, and this combination may reduce chromatic aberration of the imaging lens 10 according in this embodiment. In addition, setting the refractive power of the first lens to the third lens from the image side A2 to be positive, negative, and positive in order may improve a confocal effect of the imaging lens 10 of this embodiment in an infrared band. The interval between the second lens from the image side A2 and the third lens from the image side A2 is less than 0.3 mm, which may reduce the chromatic aberration of the imaging lens 10 according to this embodiment. The fourth lens 4 is a glass molded lens and an aspheric lens, which may reduce the difficulty of manufacturing the imaging lens 10 according to this embodiment. In addition, the imaging lens 10 includes at least five aspheric lenses, which may improve the resolution performance of the imaging lens 10 according to this embodiment.

In this embodiment, the imaging lens 10 may also meet the following conditions:
0.5 <D1/LT<1.5;
8 mm≦D1≦11 mm;
9 mm ≦LT≦15 mm;
1.6 mm <EFL<2.1 mm
4 mm ≦ DL ≦ 8 mm;
0.4 <DL/LT<0.8; and
1 <D1/DL<2.

In the above conditional formula:
D1 is a diameter on an outermost surface of the first lens 1, i.e. a straight distance between two turning points P and Q respectively at two opposite ends of the lens surface;
LT is a distance between outermost two lens surfaces (i.e., the object side surface 12 of the first lens 1 to the object side surface 72 of the seventh lens 7) of the imaging lens 10 on the optical axis I;
EFL is the effective focal length of imaging lens 10; and
DL is a diameter of an outermost surface of a lens closest to the image side A2 (i.e., the seventh lens 7) in the imaging lens 10, i.e. a straight distance between two turning points P′ and Q′ respectively at two opposite ends of the lens surface.

In another embodiment, the imaging lens 10 satisfies 8.2 mm ≦ D1 ≦ 11 mm. In yet another embodiment, the imaging lens 10 satisfies 8.2 mm ≦ D1 ≦ 10.8 mm. In another embodiment, the imaging lens 10 satisfies 9.1 mm≦LT≦ 15 mm. In yet another embodiment, the imaging lens 10 satisfies 9.1 mm≦LT≦ 14.8 mm. In another embodiment, the imaging lens 10 satisfies 1.62 mm <EFL<2.1 mm. In yet another embodiment, the imaging lens 10 satisfies 1.62 mm <EFL<2.08 mm. In another embodiment, the imaging lens 10 satisfies 4.2 mm≦DL ≦ 8 mm. In yet another embodiment, the imaging lens 10 satisfies 4.2 mm ≦DL≦7.8 mm. In another embodiment, the imaging lens 10 satisfies 0.42<DL/LT<0.8. In yet another embodiment, the imaging lens 10 satisfies 0.42<DL/LT<0.78. In another embodiment, the imaging lens 10 satisfies 1.1 <D1/DL<2. In yet another embodiment, the imaging lens 10 satisfies 1.1 <D1/DL<1.9.

In another view, the imaging lens 10 according to this embodiment includes a first lens group G1 and a second lens group G2. The first lens group G1 and the second lens group G2 respectively include three lenses with refractive power. In detail, the first lens group G1 includes three lenses with refractive power, including the first lens 1, the second lens 2, and the third lens 3. The second lens group G2 includes four lenses with refractive power, including the fourth lens 4, the fifth lens 5, the sixth lens 6, and the seventh lens 7. The aperture stop 0 of the imaging lens 10 is disposed between the first lens group G1 and the second lens group G2.

According to the above, the imaging lens 10 according to this embodiment may also meet the following conditions. The lenses of the first lens group G1 includes two aspheric lenses (i.e., the second lens 2 and the third lens 3) and a glass lens (the first lens 1). An outermost lens surface of the first lens group G1 facing the object side A1 (i.e., the object side surface 12 of the first lens 1) is a spherical surface. The lenses of the second lens group G2 includes an aspheric lens (the fourth lens 4 to the seventh lens 7 are aspheric lenses) and a glass lens (the fourth lens 4), and the second lens group G2 includes a cemented surface (the image side surface 54 of the fifth lens and the object side surface 62 of the sixth lens 6). Refractive power of the second lens group G2 is positive.

In addition, according to this embodiment, the imaging lens 10 may also meet the following conditions:
0.15 <EFL/LT<0.25; and
0.5 <D1/LT<1.5.
8 mm≦D1≦11 mm;
9 mm ≦LT≦ 15 mm;
1.6 mm <EFL<2.1 mm;
4 mm≦ DL≦ 8 mm;
0.4 <DL/LT<0.8; and
1 <D1/DL<2.

In the above conditional formula:
EFL is the effective focal length of the imaging lens 10;
LT is a distance between outermost two lens surfaces of the first lens group G1 and the second lens group G2 (i.e., the object side surface 12 of the first lens 1 to the object side surface 72 of the seventh lens 7) on the optical axis I;
D1 is a diameter of an outermost surface of an outermost lens of the first lens group G1 facing the object side A1 (i.e., the first lens 1), i.e. a straight distance between two turning points P and Q respectively at two opposite ends of the lens surface; and
DL is a diameter of an outermost surface of a lens closest to the image side A2 in the imaging lens 10 (i.e., the seventh lens 7), i.e. a straight distance between two turning points P′ and Q′ respectively at two opposite ends of the lens surface.

In another embodiment, the imaging lens 10 satisfies 0.16 <EFL/LT<0.25. In yet another embodiment, the imaging lens 10 satisfies 0.16 <EFL/LT<0.24. In another embodiment, the imaging lens 10 satisfies 0.52 <D1/LT<1.5. In yet another embodiment, the imaging lens 10 satisfies 0.52 <D1/LT<1.48.

The relevant optical values of the imaging lens 10 according to this embodiment are detailed in the attached Table 9.

Referring FIGS. 2A to FIGS. 2D again. FIG. 2A illustrates longitudinal spherical aberration in the first embodiment when wavelengths are 450 nm, 555 nm, 650 nm, and 850 nm. FIG. 2B and FIG. 2C illustrate field curvature aberration in sagittal direction and in tangential direction in the first embodiment when wavelengths are 450 nm, 555 nm, 650 nm and 850 nm on the image plane IP respectively. FIG. 2D illustrates distortion aberration on the image plane IP in the first embodiment when wavelengths are 450 nm, 555 nm, 650 nm, and 850 nm.

The longitudinal spherical aberration shown in FIG. 2A represents that the field curvature aberration of wavelength in an entire field of view falls within ±0.05 millimeters (mm). The field curvature aberration shown in FIG. 2B and FIG. 2C represents that the field curvature aberration of wavelength in an entire image height range falls within ±0.12 millimeters (mm). It can be seen that this embodiment still provides good image quality under wide viewing angle and large aperture conditions with a field of view (FOV) of 178 degrees and a f⁻number (F#) of 2, and a total system length (TTL) controlled at 13 mm.

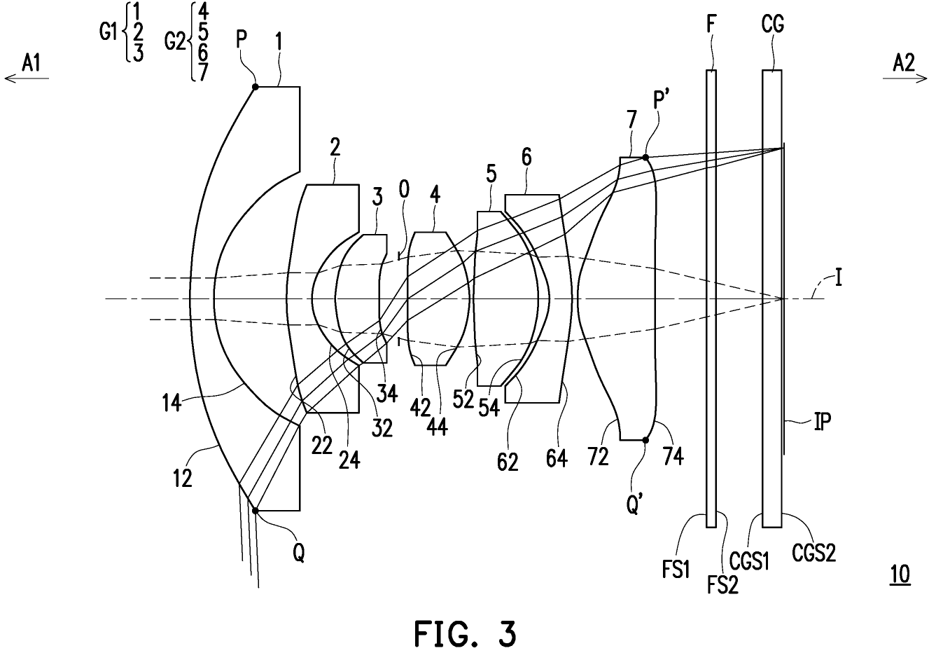

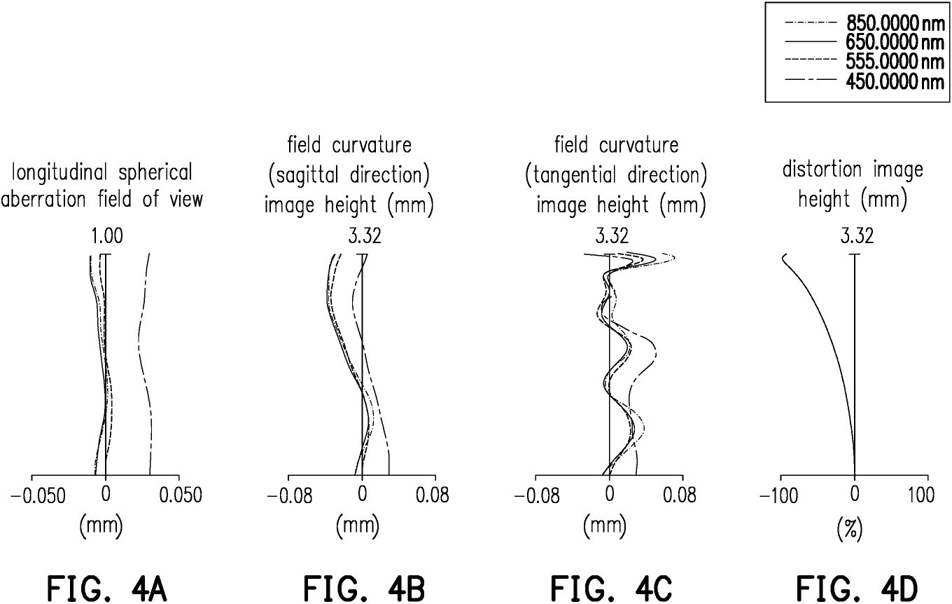

FIG. 3 is a schematic diagram of an imaging lens according to a second embodiment of the disclosure. FIGS. 4A to FIGS. 4D are diagrams illustrating aberrations of the imaging lens according to the second embodiment. Referring FIG. 3 first, the imaging lens 10 according to this embodiment is substantially similar to the first embodiment, and the difference between the two is that the fifth lens 5 and the sixth lens 6 are non-cemented lenses, and an interval between the fifth lens 5 and the sixth lens 6 is less than 0.3 mm. Therefore, the imaging lens 10 according to this embodiment may provide better imaging quality. In addition, parameters of optical data and intervals of elements of the first lens 1, the second lens 2, the third lens 3, the fourth lens 4, the fifth lens 5, the sixth lens 6, and the seventh lens 7 are not exactly the same.

An effective focal length (EFL) of the imaging lens 10 according to the second embodiment of the disclosure is 1.9 mm. An effective focal length (EFL2) of the second lens group G2 is 2.88 millimeter (mm). An f⁻number (F#) is 2.0. A field of view (FOV) is 185 degrees. A total system length (TTL) is 13 mm. A maximum image height is 3.3173 mm. Other details of optical data of the imaging lens 10 according to the second embodiment are shown in Table 3 below.

Table 3

second embodiment

| Surface No. | Radius of curvature (mm) | Interval/ Thickness (mm) | Refractive index | Abbe number | Type | Remark |
|---|---|---|---|---|---|---|
| 12 | 8.38 | 0.500 | 1.75 | 52 | spherical surface | first lens 1 (glass) |
| 14 | 2.98 | 1.606 | | | spherical surface | |
| 22 | 3.08 | 0.558 | 1.54 | 56 | aspheric surface | second lens 2 (plastic) |
| 24 | 1.01 | 0.521 | | | aspheric surface | |
| 32 | 2.37 | 0.944 | 1.66 | 20 | aspheric surface | third lens 3 (plastic) |
| 34 | 5.35 | 0.436 | | | aspheric surface | |
| | Infinity | 0.196 | | | | aperture stop 0 |
| 42 | 41.03 | 1.355 | 1.50 | 81 | aspheric surface | fourth lens 4 (glass) |
| 44 | -2.19 | 0.100 | | | aspheric surface | |
| 52 | 13.82 | 1.408 | 1.54 | 56 | aspheric surface | fifth lens 5 (plastic) |
| 54 | -3.63 | 0.255 | | | aspheric surface | |
| 62 | -1.18 | 0.495 | 1.66 | 20 | aspheric surface | sixth lens 6 (plastic) |
| 64 | -3.53 | 0.100 | | | aspheric surface | |
| 72 | 1.63 | 1.725 | 1.54 | 56 | aspheric surface | seventh lens 7 (plastic) |
| 74 | 123.09 | 1.145 | | | aspheric surface | |
| FS1 | Infinity | 0.210 | 1.52 | 64 | | filter F |
| FS2 | Infinity | 1.000 | | | | |
| CGS1 | Infinity | 0.400 | 1.52 | 64 | | plate CG |
| CGS2 | Infinity | 0.045 | | | | |
| IP | Infinity | 0 | | | | image plane IP |

The conic constant of each aspheric surface in equation (1) and each aspheric coefficient according to this embodiment are shown in Table 4.

Table 4

| | conic constant | 4^{th} aspheric coefficient | 6^{th} aspheric coefficient | 8^{th} aspheric coefficient | 10^{th} aspheric coefficient | 12^{th} aspheric coefficient | 14^{th} aspheric coefficient | 16^{th} aspheric coefficient |
|---|---|---|---|---|---|---|---|---|
| 22 | -2.75 | -6.85E-02 | 3.29E-02 | -9.51E-03 | 1.74E-03 | -1.97E-04 | 1.23E-05 | -3.26E-07 |
| 24 | -0.81 | -1.08E-01 | 1.77E-03 | 7.17E-02 | -7.26E-02 | 3.82E-02 | -1.03E-02 | 1.11E-03 |
| 32 | 0.59 | 7.15E-03 | -1.59E-02 | 3.34E-02 | -2.36E-02 | 1.00E-02 | -1.65E-03 | 0.00E+00 |
| 34 | 16.20 | 3.87E-02 | 1.26E-02 | 1.79E-03 | 1.11E-02 | 0.00E+00 | 0.00E+00 | 0.00E+00 |
| 42 | 0.00 | 1.31E-02 | 6.65E-03 | 7.79E-04 | 0.00E+00 | 0.00E+00 | 0.00E+00 | 0.00E+00 |
| 44 | -6.31 | -6.39E-02 | 2.58E-02 | -4.51E-03 | -6.36E-03 | 3.44E-03 | -3.95E-04 | 0.00E+00 |
| 52 | 8.71 | -2.89E-03 | 3.37E-03 | 9.90E-04 | -2.10E-03 | 6.46E-04 | -6.21E-05 | 0.00E+00 |
| 54 | -1.25 | -3.47E-02 | -4.85E-02 | 6.75E-02 | -3.55E-02 | 9.33E-03 | -1.22E-03 | 6.44E-05 |
| 62 | -5.45 | -4.62E-02 | -5.18E-03 | 3.53E-02 | -2.54E-02 | 7.96E-03 | -1.18E-03 | 6.67E-05 |
| 64 | -17.15 | -4.97E-03 | 2.49E-02 | -1.54E-02 | 4.46E-03 | -6.96E-04 | 5.66E-05 | -1.90E-06 |
| 72 | -8.28 | 1.02E-02 | -3.09E-03 | 8.34E-04 | -1.59E-04 | 1.68E-05 | -9.25E-07 | 1.99E-08 |
| 74 | -0.16 | -6.25E-03 | 1.96E-03 | -3.51E-05 | -5.27E-05 | 6.55E-06 | -2.81E-07 | 2.53E-09 |

The relevant optical values of the imaging lens 10 according to this embodiment are detailed in the attached Table 9.

Referring FIGS. 4A to FIGS. 4D, the longitudinal spherical aberration shown in FIG. 4A represents that the field curvature aberration of wavelength in an entire field of view falls within ±0.05 millimeters (mm). The field curvature aberration shown in FIG. 4B and FIG. 4C represents that the field curvature aberration of wavelength in an entire image height range falls within ±0.08 millimeters (mm). It can be seen that this embodiment still provides good image quality under wide viewing angle and large aperture conditions with a field of view (FOV) of 185 degrees and a f⁻number (F#) of 2.0, and a total system length (TTL) controlled at 13 mm.

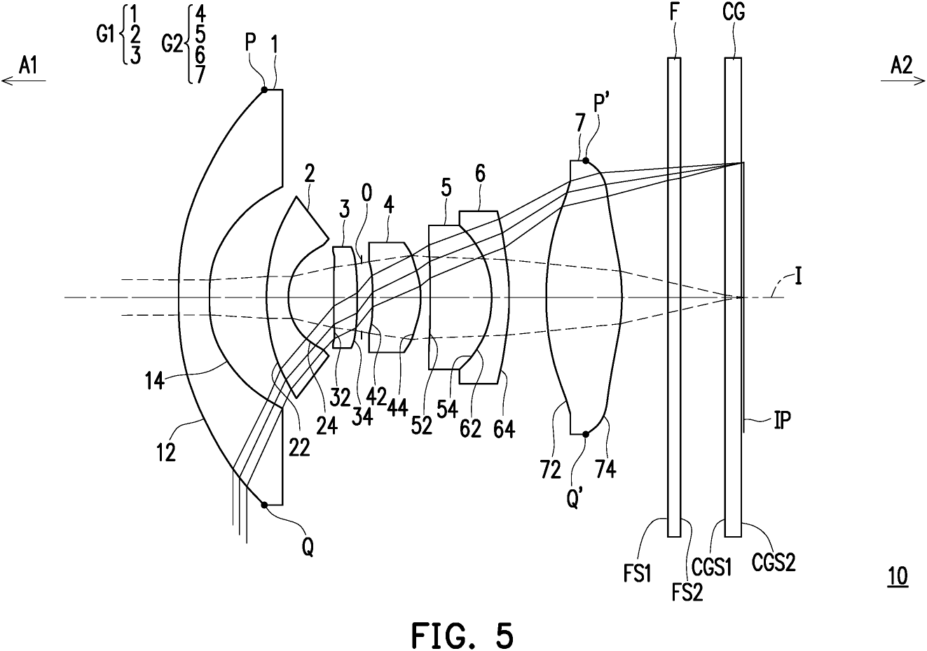

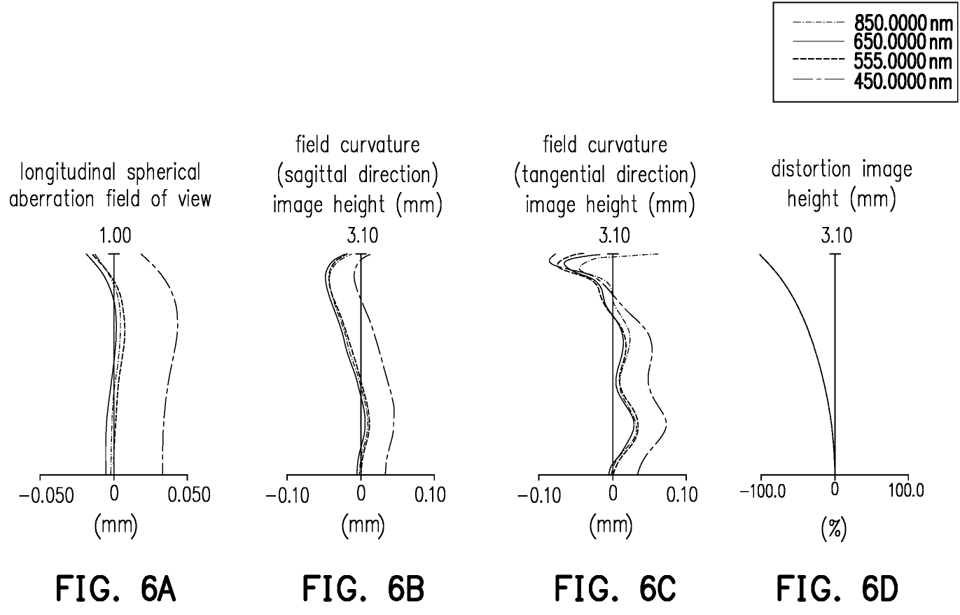

FIG. 5 is a schematic diagram of an imaging lens of according to a third embodiment of the disclosure. FIGS. 6A to FIGS. 6D are diagrams illustrating aberrations of the imaging lens according to the third embodiment. Referring FIG. 5 first, the imaging lens 10 according to this embodiment is substantially similar to the first embodiment, and the difference between the two is that the fifth lens 5 is a glass lens and a spherical lens, the sixth lens 6 is a glass lens and a spherical lens, and the fourth lens 4 is a general spherical glass lens. Therefore, the imaging lens 10 according to this embodiment may tolerate higher manufacturing tolerance. In addition, parameters of optical data and intervals of elements of the first lens 1, the second lens 2, the third lens 3, the fourth lens 4, the fifth lens 5, the sixth lens 6, and the seventh lens 7 are not exactly the same.

An effective focal length (EFL) of the imaging lens 10 according to the third embodiment of the disclosure is 1.8 mm. An effective focal length (EFL2) of the second lens group G2 is 3.13 millimeter (mm). An f⁻number (F#) is 2.2. A field of view (FOV) is 180 degrees. A total system length (TTL) is 13 mm. A maximum image height is 3.1 mm. Other details of optical data of the imaging lens 10 according to the third embodiment are shown in Table 5 below.

Table 5

third embodiment

| Surface No. | Radius of curvature (mm) | Interval/ Thickness (mm) | Refractive index | Abbe number | Type | Remark |
|---|---|---|---|---|---|---|
| 12 | 6.78 | 0.710 | 1.75 | 52 | spherical surface | first lens 1 (glass) |
| 14 | 2.77 | 1.319 | | | spherical surface | |
| 22 | 5.18 | 0.500 | 1.54 | 56 | aspheric surface | second lens 2 (plastic) |
| 24 | 1.37 | 1.041 | | | aspheric surface | |
| 32 | 15.24 | 0.550 | 1.64 | 24 | aspheric surface | third lens 3 (plastic) |
| 34 | -6.33 | 0.100 | | | aspheric surface | |
| | Infinity | 0.252 | | | | aperture stop 0 |
| 42 | -4.49 | 1.100 | 1.91 | 35 | spherical surface | fourth lens 4 (glass) |
| 44 | -2.30 | 0.224 | | | spherical surface | |
| 52 | -18.25 | 1.411 | 1.75 | 52 | spherical surface | fifth lens 5 (glass) object side surface |
| 54/ 62 | -2.23 | 0.400 | 1.99 | 16 | spherical surface | fifth lens 5 (glass) image side surface/ sixth lens 6 (glass) object side surface |
| 64 | -7.42 | 0.861 | | | spherical surface | sixth lens 6 (glass) image side surface |
| 72 | 7.02 | 1.733 | 1.54 | 56 | aspheric surface | seventh lens 7 (plastic) |
| 74 | -4.56 | 1.057 | | | aspheric surface | |
| FS1 | Infinity | 0.300 | 1.52 | 64 | | filter F |
| FS2 | Infinity | 1.000 | | | | |
| CGS1 | Infinity | 0.400 | 1.52 | 64 | | plate CG |
| CGS2 | Infinity | 0.045 | | | | |
| IP | Infinity | 0.000 | | | | image plane IP |

The conic constant of each aspheric surface in equation (1) and each aspheric coefficient according to this embodiment are shown in Table 6.

Table 6

| | conic constant | 4^{th} aspheric coefficient | 6^{th} aspheric coefficient | 8^{th} aspheric coefficient | 10^{th} aspheric coefficient | 12^{th} aspheric coefficient | 14^{th} aspheric coefficient | 16^{th} aspheric coefficient |
|---|---|---|---|---|---|---|---|---|
| 22 | 0.00 | 3.06E-02 | -9.10E-03 | -1.05E-03 | 1.19E-03 | -2.61E-04 | 1.90E-05 | 0.00E+00 |
| 24 | 0.00 | 7.57E-02 | -1.24E-01 | 3.13E-01 | -4.53E-01 | 3.18E-01 | -8.63E-02 | 0.00E+00 |
| 32 | 0.00 | -7.87E-03 | -1.80E-02 | 2.05E-02 | -2.08E-02 | 0.00E+00 | 0.00E+00 | 0.00E+00 |
| 34 | 0.00 | -8.73E-04 | 2.53E-04 | -7.71E-03 | 0.00E+00 | 0.00E+00 | 0.00E+00 | 0.00E+00 |
| 72 | 0.00 | 1.20E-04 | 2.52E-03 | -1.30E-03 | 3.62E-04 | -5.98E-05 | 5.43E-06 | -2.16E-07 |
| 74 | 0.00 | 1.14E-02 | 6.95E-04 | -1.67E-04 | -2.57E-05 | 1.06E-05 | -1.22E-06 | 4.43E-08 |

The relevant optical values of the imaging lens 10 according to this embodiment are detailed in the attached Table 9.

Referring FIGS. 6A to FIGS. 6D, the longitudinal spherical aberration shown in FIG. 6A represents that the field curvature aberration of wavelength in an entire field of view falls within ±0.05 millimeters (mm). The field curvature aberration shown in FIG. 6B and FIG. 6C represents that the field curvature aberration of wavelength in an entire image height range falls within ±0.1 millimeters (mm). It can be seen that this embodiment still provides good image quality under wide viewing angle and large aperture conditions with a field of view (FOV) of 180 degrees and a aperture number (F#) of 2.2, and a total system length (TTL) controlled at 13 mm.

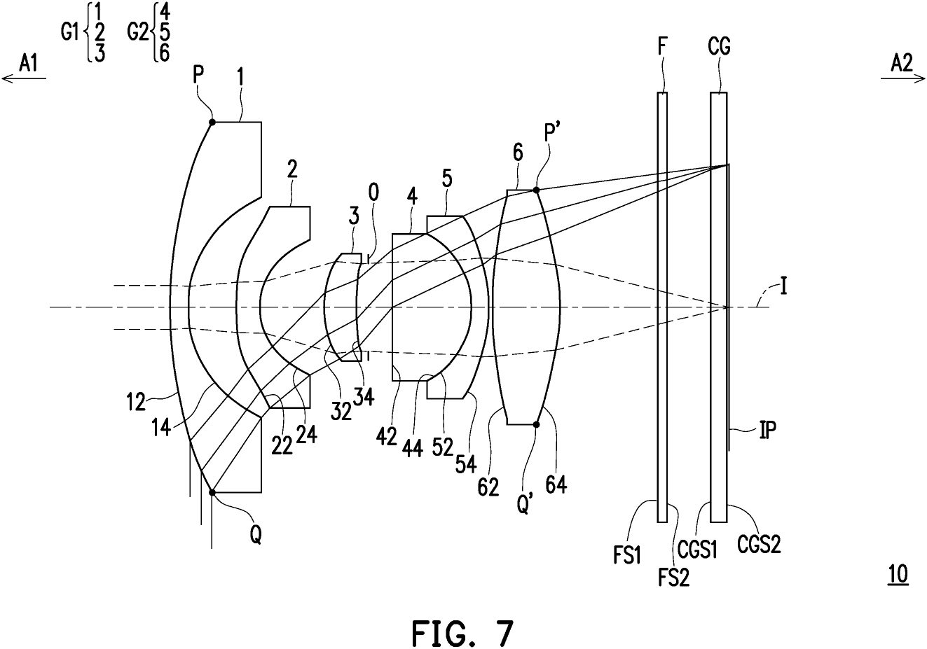

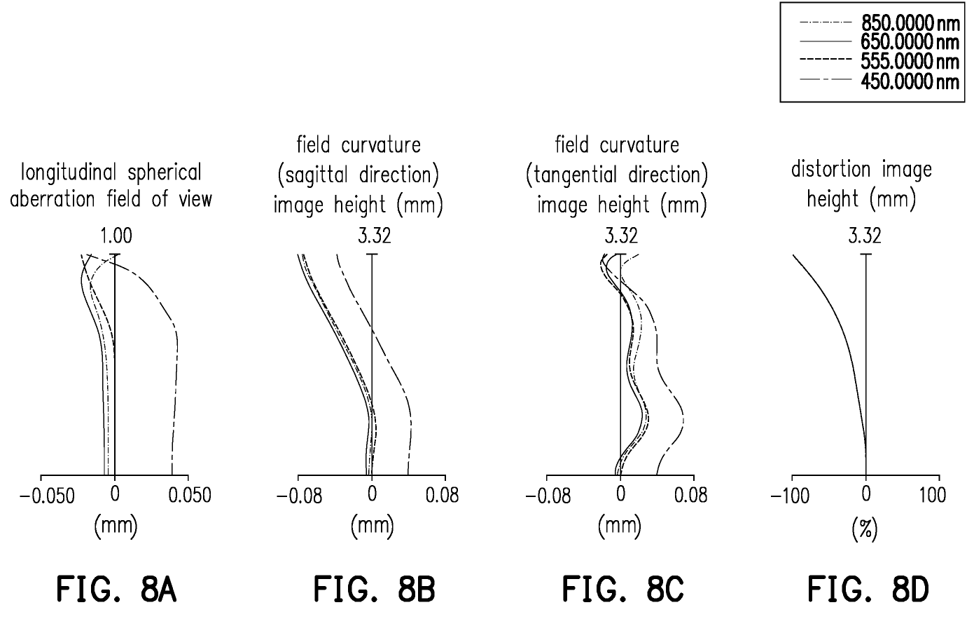

FIG. 7 is a schematic diagram of an imaging lens of according to a fourth embodiment of the disclosure. FIGS. 8A to FIGS. 8D are diagrams illustrating aberrations of the imaging lens according to the fourth embodiment. Referring FIG. 7 first, the imaging lens 10 according to this embodiment is substantially similar to the first embodiment, and the difference between the two is that a number of lenses with refractive power in the imaging lens 10 is substantially six, the fourth lens 4 is a general spherical glass lens, and the fifth lens 5 is a glass lens and a spherical surface lens. Therefore, the manufacturing cost of the imaging lens 10 according to this embodiment may be reduced. The fourth lens 4 and the fifth lens 5 are joined on the image side surface 44 of the fourth lens 4 and the object side surface 52 of the fifth lens 5 to form a cemented lens. The second lens group G2 includes three lenses with refractive power, including the fourth lens 4, the fifth lens 5, and the sixth lens 6. In addition, parameters of optical data and intervals of elements of the first lens 1, the second lens 2, the third lens 3, the fourth lens 4, the fifth lens 5, and the sixth lens 6 are not exactly the same.

An effective focal length (EFL) of the imaging lens 10 according to the fourth embodiment of the disclosure is 1.9 mm. An effective focal length (EFL2) of the second lens group G2 is 3.57 millimeter (mm). An f⁻number (F#) is 2. A field of view (FOV) is 180 degrees. A total system length (TTL) is 13 mm. A maximum image height is 3.3173 mm. Other details of optical data of the imaging lens 10 according to the fourth embodiment are shown in Table 7 below.

Table 7

fourth embodiment

| Surface No. | Radius of curvature (mm) | Interval/ Thickness (mm) | Refractive index | Abbe number | Type | Remark |
|---|---|---|---|---|---|---|
| 12 | 10.08 | 0.431 | 1.75 | 52 | spherical surface | first lens 1 (glass) |
| 14 | 2.78 | 1.115 | | | spherical surface | |
| 22 | 7.26 | 0.543 | 1.54 | 56 | aspheric surface | second lens 2 (plastic) |
| 24 | 1.83 | 1.505 | | | aspheric surface | |
| 32 | 2.87 | 0.759 | 1.64 | 24 | aspheric surface | third lens 3 (plastic) |
| 34 | 15.94 | 0.255 | | | aspheric surface | |
| | Infinity | 0.561 | | | | aperture stop 0 |
| 42 | Infinity | 1.840 | 1.75 | 52 | spherical surface | fourth lens 4 (glass) object side surface |
| 44/ 52 | -1.92 | 0.400 | 1.99 | 16 | spherical surface | fourth lens 4 (glass) image side surface/ fifth lens 5 (glass) object side surface |
| 54 | -4.07 | 0.100 | | | spherical surface | fifth lens 5 (glass) image side surface |
| 62 | 9.45 | 1.563 | 1.54 | 56 | aspheric surface | sixth lens 6 (plastic) |
| 64 | -4.76 | 2.276 | | | aspheric surface | |
| FS1 | Infinity | 0.210 | 1.52 | 64 | | filter F |
| FS2 | Infinity | 1.000 | | | | |
| CGS1 | Infinity | 0.400 | 1.52 | 64 | | plate CG |
| CGS2 | Infinity | 0.045 | | | | |
| IP | Infinity | 0.000 | | | | image plane IP |

The conic constant of each aspheric surface in equation (1) and each aspheric coefficient according to this embodiment are shown in Table 8.

Table 8

| | conic constant | 4^{th} aspheric coefficient | 6^{th} aspheric coefficient | 8^{th} aspheric coefficient | 10^{th} aspheric coefficient | 12^{th} aspheric coefficient | 14^{th} aspheric coefficient | 16^{th} aspheric coefficient |
|---|---|---|---|---|---|---|---|---|
| 22 | 0.00 | 5.56E-02 | -1.72E-02 | 3.94E-03 | -7.45E-04 | 8.23E-05 | -3.70E-06 | 0.00E+00 |
| 24 | 0.00 | 8.78E-02 | -1.59E-02 | 1.71E-03 | 5.01E-04 | -7.20E-04 | 4.95E-05 | 0.00E+00 |
| 32 | 0.00 | 2.68E-02 | -5.14E-04 | 1.45E-02 | -1.03E-02 | 4.34E-03 | -2.73E-04 | 0.00E+00 |
| 34 | 0.00 | 2.71E-02 | 2.53E-03 | 1.77E-02 | -1.40E-02 | 8.58E-03 | 0.00E+00 | 0.00E+00 |
| 62 | 0.00 | 4.05E-04 | -4.50E-05 | 1.97E-06 | -5.34E-06 | 3.13E-07 | -1.13E-09 | 0.00E+00 |
| 64 | 0.00 | 8.20E-03 | -3.98E-04 | 9.42E-05 | -1.94E-05 | 1.29E-06 | -2.34E-08 | 0.00E+00 |

According to the above, the imaging lens 10 according to this embodiment may meet the following conditions. The first lens 1 is a glass lens, and at least one of the fourth lens 4, the fifth lens 5, and the sixth lens 6 is a glass lens. In the imaging lens 10, the second lens from the image side A2 (the fifth lens 5) is a negative lens, the third lens from the image side A2 (the fourth lens 4) is a positive lens, and an interval between the second lens from the image side A2 and the third lens from the image side A2 is less than 0.3 mm. In addition, in the imaging lens 10, a distance between a concave surface and a convex surface closest to each other (the image side surface 44 of the fourth lens 4 and the object side surface 52 of the fifth lens 5) is less than 0.3 mm.

The imaging lens 10 according to this embodiment may also meet the following conditions. The lenses of the second lens group G2 includes an aspheric lens (the sixth lens 6) and a glass lens (the fourth lens 4 and the fifth lens 5), and the second lens group G2 includes a cemented surface (the image side surface 44 of the fourth lens 4 and the object side surface 52 of the fifth lens 5). The refractive power of the second lens group G2 is positive.

The imaging lens 10 according to this embodiment may also meet the previously listed conditions. LT is a distance between outermost two lens surfaces of the imaging lens 10 (i.e., the object side surface 12 of the first lens 1 to the object side surface 62 of the sixth lens 6) on the optical axis I, or a distance between outermost two lens surfaces of the first lens group G1 and the second lens group G2 (i.e., the object side surface 12 of the first lens 1 to the object side surface 62 of the sixth lens 6) on the optical axis I. DL is a diameter of an outermost surface of a lens closest to the image side A2 in the imaging lens 10 (i.e., the sixth lens 6), i.e. a straight distance between two turning points P′ and Q′ respectively at two opposite ends of the lens surface.

The relevant optical values of the imaging lens 10 according to this embodiment are detailed in the attached Table 9.

Referring FIGS. 8A to FIGS. 8D, the longitudinal spherical aberration shown in FIG. 8A represents that the field curvature aberration of wavelength in an entire field of view falls within ±0.05 millimeters (mm). The field curvature aberration shown in FIG. 8B and FIG. 8C represents that the field curvature aberration of wavelength in an entire image height range falls within ±0.08 millimeters (mm). It can be seen that this embodiment still provides good image quality under wide viewing angle and large aperture conditions with a field of view (FOV) of 180 degrees and a aperture number (F#) of 2, and a total system length (TTL) controlled at 13 mm.

Table 9 lists the relative optical values of the imaging lens 10 according to the first embodiment to the fourth embodiment. The units of each parameter of column “EFL”, column “EFL2”, column “TTL”, and column “LT” are millimeters (mm). The unit of column “FOV” is degree.

Table 9

| | first embodiment | second embodiment | third embodiment | fourth embodiment |
|---|---|---|---|---|
| EFL | 1.94 | 1.9 | 1.8 | 1.9 |
| EFL2 | 3.19 | 2.88 | 3.13 | 3.57 |
| F# | 2 | 2.0 | 2.2 | 2 |
| FOV | 178 | 185 | 180 | 180 |
| TTL | 13 | 13 | 13 | 13 |
| maximum image height | 3.3173 | 3.3173 | 3.1 | 3.3173 |
| D1 | 8.71 | 9.3 | 8.7 | 8.6 |
| DL | 6.28 | 6.2 | 5.7 | 5.5 |
| LT | 10.2 | 10.2 | 10.2 | 9.1 |
| DL/LT | 0.6 | 0.6 | 0.6 | 0.6 |
| EFL/LT | 0.19 | 0.19 | 0.18 | 0.21 |
| DI/LT | 0.85 | 0.91 | 0.85 | 0.95 |
| D1/DL | 1.39 | 1.50 | 1.53 | 1.56 |

In summary, the imaging lens according to the embodiments of the disclosure is capable of providing good image quality under wide viewing angle and large aperture conditions by meeting the above-mentioned element characteristics and configuration conditions, and may also take into account the need for miniaturization. The imaging lens according to the embodiments of the disclosure may provide good image quality with an f⁻number of 2.0, a field of view of about 180 degrees, and a total system length controlled within 13 mm. In addition, the imaging lens according to the embodiments of the disclosure, by appropriately setting glass and plastic lenses with spherical and aspheric surfaces, enables the imaging lens to withstand higher temperatures and temperature changes in the use environment, while reducing manufacturing costs and taking care of image quality.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An imaging lens comprising:
a first lens group and a second lens group, wherein the first lens group and the second lens group respectively comprise three lenses with refractive power;
the lenses of the first lens group comprise two aspheric lenses and a glass lens, and an outermost lens surface of the first lens group facing an object side is a spherical surface;
the lenses of the second lens group comprise an aspheric lens and a glass lens, and the second lens group comprises a cemented surface;
an aperture stop of the imaging lens disposed between the first lens group and the second lens group; wherein the imaging lens meets the following conditions:
0.15 <EFL/LT<0.25 and 0.5<D1/LT<1.5;
wherein EFL is an effective focal length of the imaging lens, LT is a distance on an optical axis between outermost two lens surfaces of the first lens group and the second lens group, and D1 is a diameter of an outermost surface of an outermost lens of the first lens group facing the object side.

2. The imaging lens according to claim 1, wherein the imaging lens meets the following conditions: 8 mm≦D1≦11 mm; 9 mm≦LT≦<15 mm; and 1.6 mm <EFL<2.1 mm.

3. The imaging lens according to claim 1, wherein the imaging lens meets the following conditions: 4 mm≦ DL≦ 8 mm; 0.4 <DL/LT<0.8; and 1 <D1/DL<2; wherein DL is a diameter of an outermost surface of a lens closest to an image side in the imaging lens.

4. The imaging lens according to claim 1, wherein the refractive power of the second lens group is positive.

5. The imaging lens according to claim 1, wherein a distance between a concave surface and a convex surface closest to each other of the imaging lens is less than 0.3 mm.

6. The imaging lens according to claim 1, wherein a number of lenses with refractive power in the imaging lens is substantially seven.

7. An imaging lens comprising:
a first lens, a second lens, a third lens, a fourth lens, a fifth lens, and a sixth lens arranged in order from an object side to an image side of the imaging lens, and an aperture stop disposed between the third lens and the fourth lens;
wherein the first lens is a glass lens, and at least one of the fourth lens, the fifth lens, and the sixth lens is a glass lens;
wherein the second lens from the image side in the imaging lens is a negative lens, the third lens from the image side is a positive lens, and an interval between the second lens from the image side and the third lens from the image side is less than 0.3 mm;
wherein the imaging lens meets the following conditions at the same time: 0.5 <D1/LT<1.5;
wherein LT is a distance on an optical axis between outermost two lens surfaces of the imaging lens, and D1 is a diameter of an outermost surface of the first lens.

8. The imaging lens according to claim 7, wherein the imaging lens meets the following conditions: 8 mm≦ D1 ≦11 mm; 9 mm≦ LT≦ 15 mm; and 1.6 mm <EFL<2.1 mm, wherein EFL is an effective focal length of the imaging lens.

9. The imaging lens according to claim 7, wherein the imaging lens meets the following conditions: 4 mm ≦DL ≦8 mm; 0.4 <DL/LT<0.8; and 1 <D1/DL<2; wherein DL is a diameter of an outermost surface of a lens closest to the image side in the imaging lens.

10. The imaging lens according to claim 7, wherein the fourth lens is a glass molded lens and is an aspheric lens.

11. The imaging lens according to claim 7, wherein a distance between a concave surface and a convex surface closest to each other of the imaging lens is less than 0.3 mm.

12. The imaging lens according to claim 7, wherein a number of lenses with refractive power in the imaging lens is substantially seven.

13. The imaging lens according to claim 12, wherein the fifth lens and the sixth lens form a cemented lens.

14. The imaging lens according to claim 13, wherein a cemented surface of the fifth lens and the sixth lens is an aspheric surface.

15. The imaging lens according to claim 14, wherein the fifth lens and the sixth lens form a plastic cemented lens.

16. The imaging lens according to claim 12, wherein the imaging lens comprises a seventh lens, the first lens and the fourth lens are glass lenses, and the second lens, the third lens, and the seventh lens are plastic lenses.

17. The imaging lens according to claim 16, wherein the fifth lens and the sixth lens are plastic lenses.

18. The imaging lens according to claim 16, wherein the fifth lens and the sixth lens are glass lenses.

19. The imaging lens according to claim 12, wherein the imaging lens comprises five aspheric lenses.

20. The imaging lens according to claim 12, wherein from the object side to the image side, the refractive power of the seven lenses with refractive power in the imaging lens is in the following order: negative, negative, positive, positive, positive, negative, positive.
